(19) United States
(12) Patent Application Publication
(10) Pub. No.: US 2014/0053116 A1
(43) Pub. Date: Feb. 20, 2014

(54) APPLICATION CONTROL IN ELECTRONIC DEVICES

(71) Applicants: Michael Smith, London (GB); Sheen Yap, London (GB); Tim Russell, London (GB); Kevin Joyce, London (GB); Ken Johnstone, London (GB); Nicola Eger, London (GB); Alexis Gupta, London (GB)

(72) Inventors: Michael Smith, London (GB); Sheen Yap, London (GB); Tim Russell, London (GB); Kevin Joyce, London (GB); Ken Johnstone, London (GB); Nicola Eger, London (GB); Alexis Gupta, London (GB)

(73) Assignee: INQ ENTERPRISES LIMITED, NASSAU, NEW PROVIDENCE (BS)

(21) Appl. No.: 14/114,500

(22) PCT Filed: Apr. 30, 2012
(86) PCT No.: PCT/GB2012/000397

§ 371 Date: Oct. 28, 2013

(30) Foreign Application Priority Data
Apr. 28, 2011 (GB) 1107273.3

(51) Int. Cl. G06F 3/01

(52) U.S. Cl. CPC G06F 3/017
USPC 715/863

(57) ABSTRACT

A portable electronic device is provided, comprising a display screen area for providing visual feedback and for receiving gestures inputs, and a switching controller to enable switching between multiple applications that have been executed on the device, the switching controller being adapted to interact with an operating system on the device and including a number of software components that interact with components that are native to an operating system on the device, and wherein the device further comprises a processor for invoking procedures relating to the particular components of the switching controller, wherein the switching controller comprises a task management component for maintaining an ordered list of tasks that are running on the device and allowing for task status to be changed. A method is also provided for controlling switching between a plurality of applications in a portable electronic device, the method comprising a display screen wherein the method includes generating an ordered list of the plurality of applications that are running on a device and controlling switching between the applications on the basis of the list. A computer readable medium comprises computer program code for causing an electronic device to carry out the method

The present invention relates to application control in electronic devices and particularly, to an apparatus, method and computer readable medium for controlling application programs that may be running on portable electronic devices.

Multitasking on portable electronic devices such as mobile telephones and switching between running applications in response to gestures is known in the mobile phone environment. However, in a mobile environment, multitasking has some unique challenges. Particularly, understanding which applications are running and how a user can switch between running applications present particular challenges.

In a multitasking environment, it is desirable to allow a user to quickly move between different running applications. Typically, when a user needs to select a different application or screen in an application, a menu is shown that the user then selects a desired running application or screen from.

The present invention provides methods, apparatuses, systems and computer readable mediums that enable switching of tasks in systems in a user-friendly manner.

According to one aspect, the present invention provides an electronic device comprising a switching controller to enable users to switch between multiple applications that have been executed on the device, the switching mechanism being adapted to in interact with an operating system on the device. The operating system may not have the capability of switching between applications.

The switching controller includes a number of software components that interact with the components that are native to the operating system on the device. The interaction occurs through the processor on the phone which can invoke procedures relating to the particular components of the switching controller.

The switching controller may comprise a task management component which maintains an ordered list of tasks that are running on the device and allows for task status to be changed (open or closed). The controller may further comprise a swipe manager component which is capable of switching between tasks. The controller may also comprise a gesture detection component to identify a particular type of gesture on a predefined area of the electronic device.

The processor referred to herein may comprise a data processing unit and associated program code to control the performance of operations by the processor.

A method for controlling switching between a plurality of applications in an electronic device may be provided, wherein the method includes generating a list of the plurality of applications that have been executed on the device and controlling switching between the applications on the basis of the list. The order of the list can be changed by a user.

A computer readable medium may be provided that comprises computer program code for causing an electronic device to carry out the aforementioned method.

In one embodiment, running applications are presented as screenshots in an ordered list that show the display of each running application, and users can, through gestures, easily switch between running applications. The screenshots can be captured automatically when task swiping is initiated rather than the user having to carry out a procedure to capture the screenshots. A default screen which may list all available applications that can be run on the device or a home/widget screen, is placed at one end of the list (to the left in this embodiment), and is always there. Users can reorder applications in the list and remove applications from the list using an application program which shows all running applications as miniature screenshots with close buttons and users can drag the screenshots to reorder them. This creates a spatial understanding of the locations of applications in the user's mind, allowing them to more efficiently switch between running applications and find the applications they desire.

One advantage is that unique user experiences have been created that aid the user in understanding the placement in the list for new applications. Specifically, using unique animations, the display demonstrates to the user the resulting ordering of the new applications in the list.

In one embodiment, it is possible to distinguish between new screens in an application and a new application being launched. This is particularly important in a mobile environment where applications work together and not in isolation, such as an email link in a browser launching an email application, and distinguishing that from a link launching a new browser window.

When a new application is launched from a foregrounded application (the ‘initiating screen’), the new application appears in a screen adjacent to and displacing the initiating screen. This new application is shown to the foreground initially. When a second new application is opened (the new ‘initiating screen’), the first application is pushed out away from the initiating screen and the new application is then shown in the foreground. To switch to the first application, the screen is swiped in the opposite direction of the initiating screen, changing back to the first application. The initiating screen may or may not be the ‘Home screen’.

This provides ease of use for switching application focus; switching between views of a set of running applications and understanding the ordered list of running applications. By enabling direct switch from full screen display of a first application to full screen display of another application, the invention avoids the need to return to an intermediate selection menu when wishing to navigate between applications. This increases the ease with which users manage and navigate between applications compared with having to step back through an interface hierarchy.

According to an aspect of the present invention, users can reorder applications in the list and remove applications (e.g. using drag and drop and close buttons but also in response to the user selecting an application from a menu), and this controls a subsequent switching sequence.

An electronic device that may be suitable for use in the above embodiments has a display screen area for providing visual feedback and for receiving gestures and a gesture control area that may be separate from the display screen. The gesture control area recognises predetermined types of gestures which may provide different functionality to the device compared to if the same gesture was received in the display screen. Swiping in this gesture control area causes navigation through the list of applications. This may be different to swiping in the display screen area which may cause navigation through the various Home or other screens that an electronic device may be able to display.

Embodiments of the invention are described below in more detail, by way of example, with reference to the accompanying drawings in which:

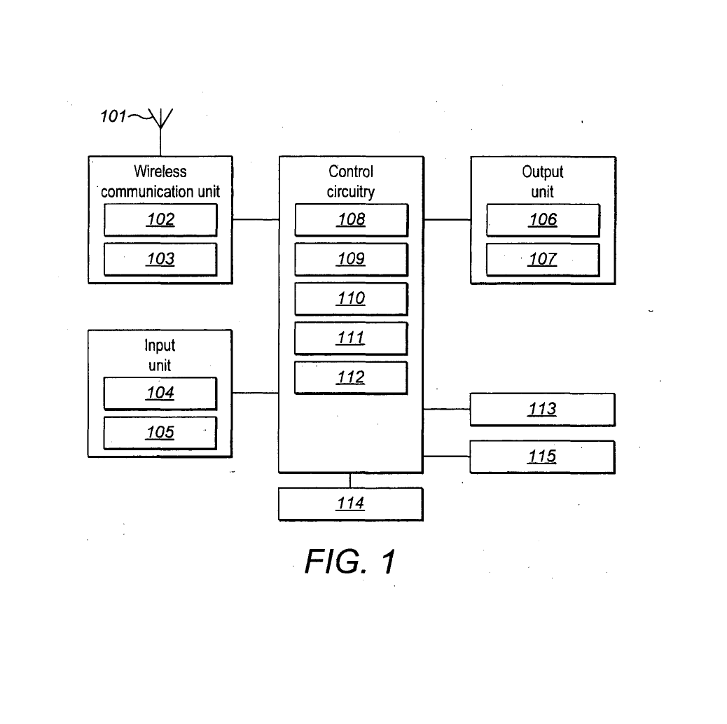

FIG. 1 is a schematic representation of a mobile telephone, as a first example of an electronic device in which the invention may be implemented;

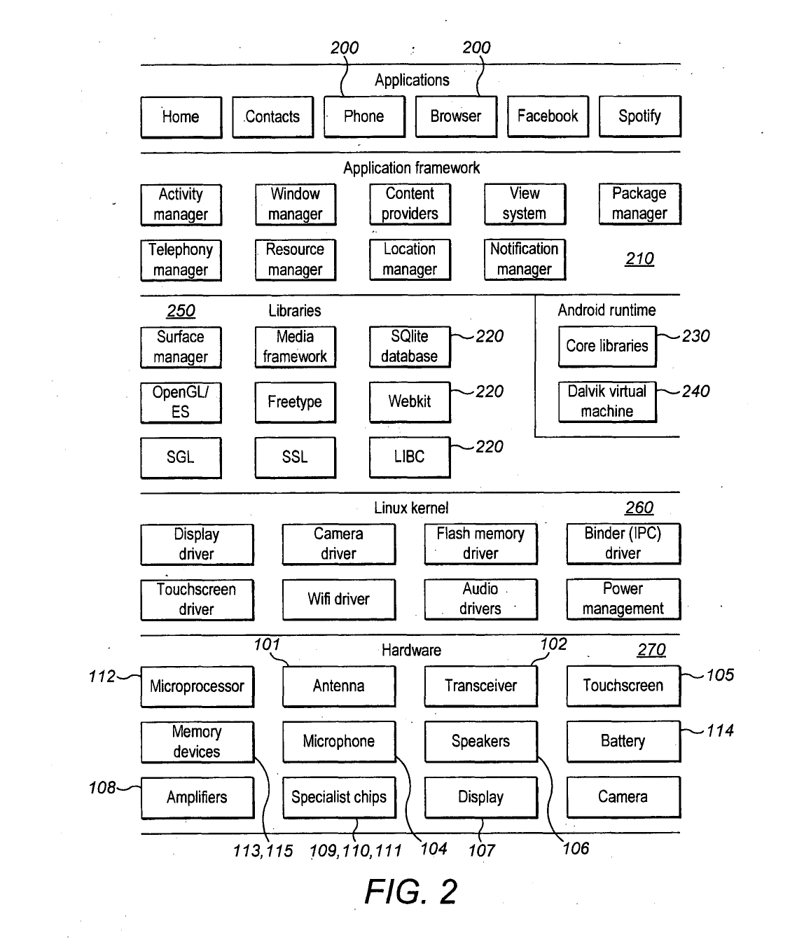

FIG. 2 is an architecture diagram of the Android operating system.

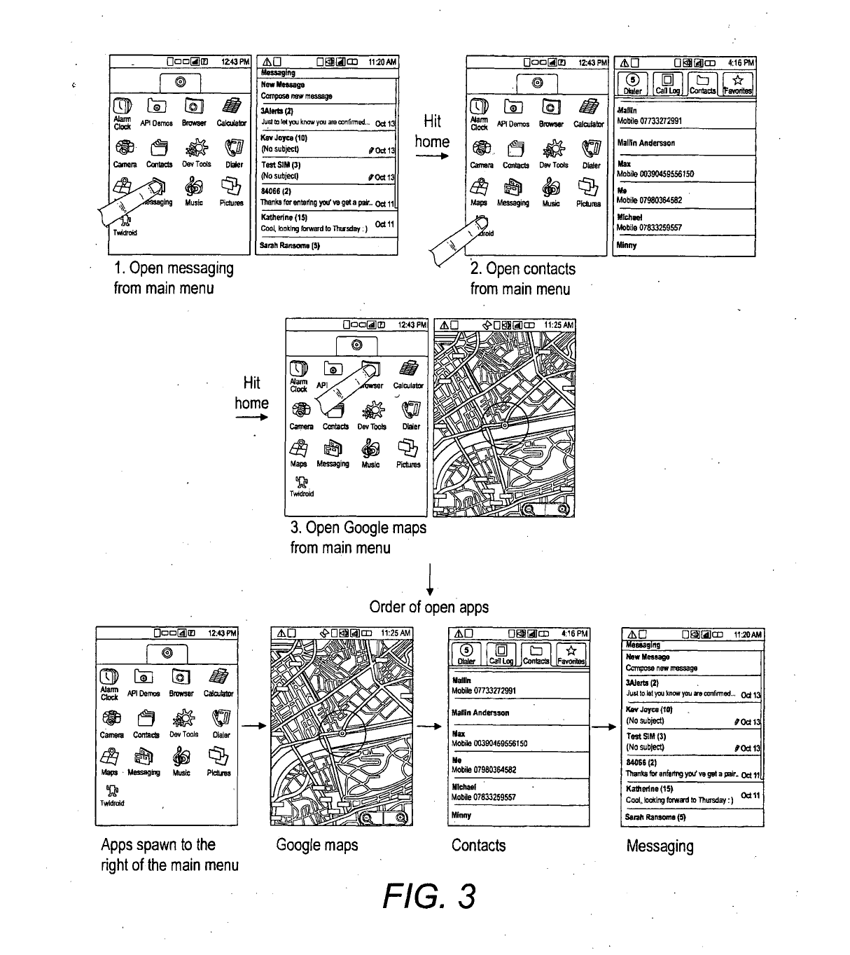

FIG. 3 is a diagram showing user interfaces that may be visible on the screen of an electronic device according to an embodiment of the invention.

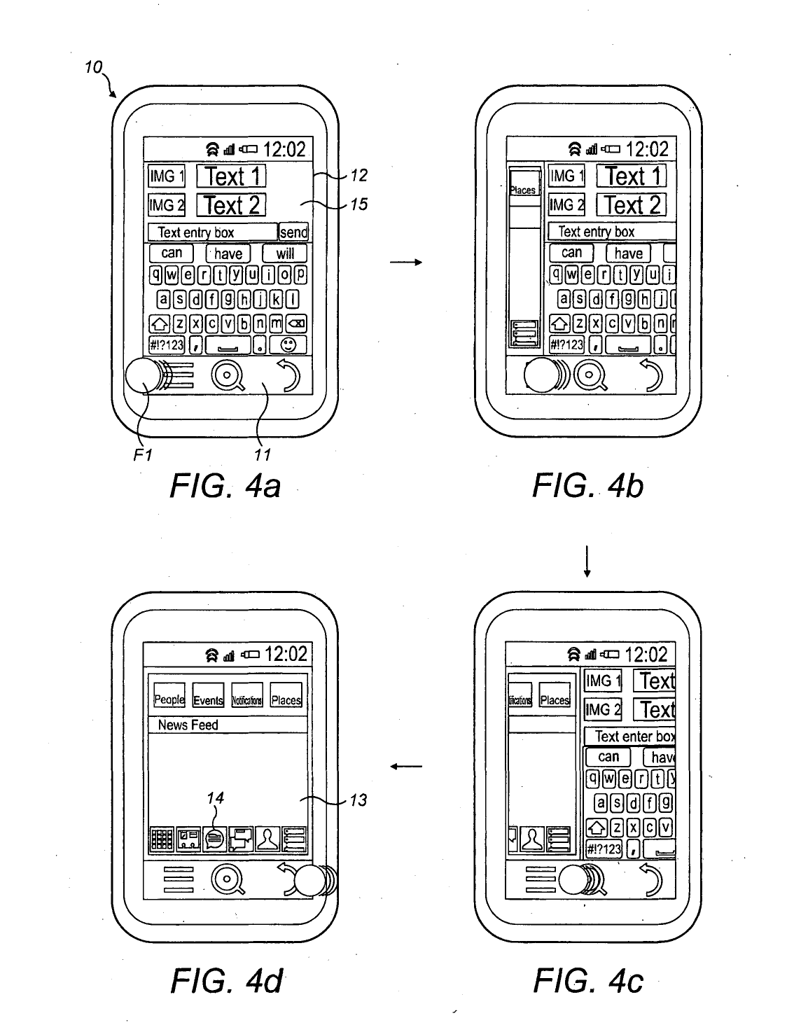

FIGS. 4a to 4d show an electronic device that is used in the embodiment of FIG. 3 and different user interfaces that are displayed on the screen following user interactions with the device.

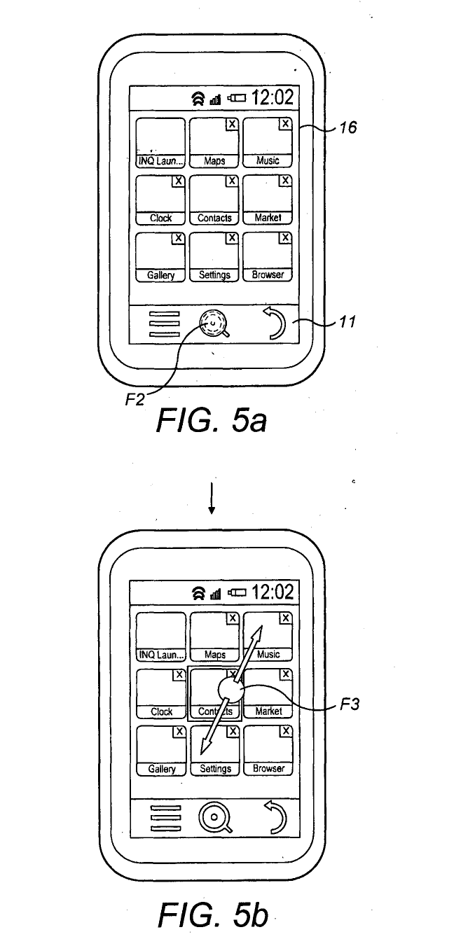

FIGS. 5a and 5b show an electronic device that is used in the embodiment of FIG. 3 and different user interfaces that are displayed on the screen when a Home button on the device is held;

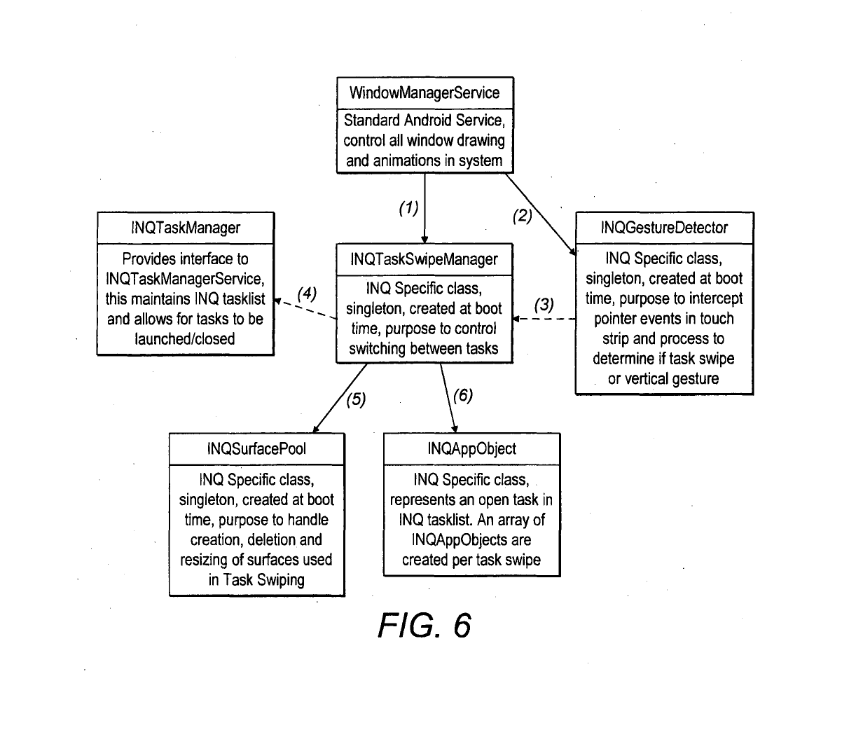

FIG. 6 shows an architecture diagram including a list of classes and their interactions to provide task swiping in a mobile electronic device such as that in FIG. 4;

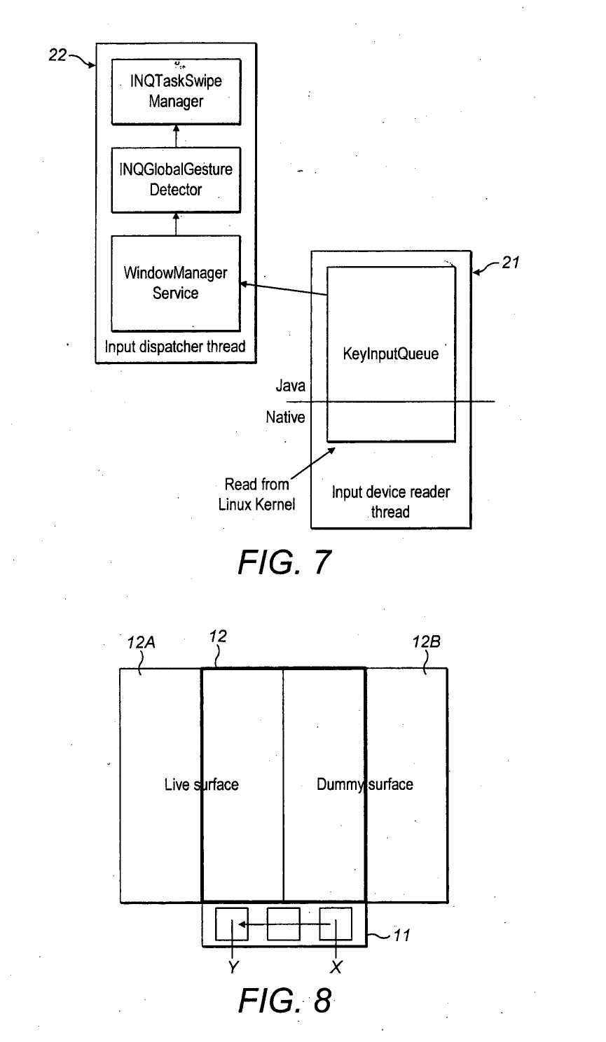

FIG. 7 is an architecture diagram of components providing gesture detection in the embodiment of FIG. 3;

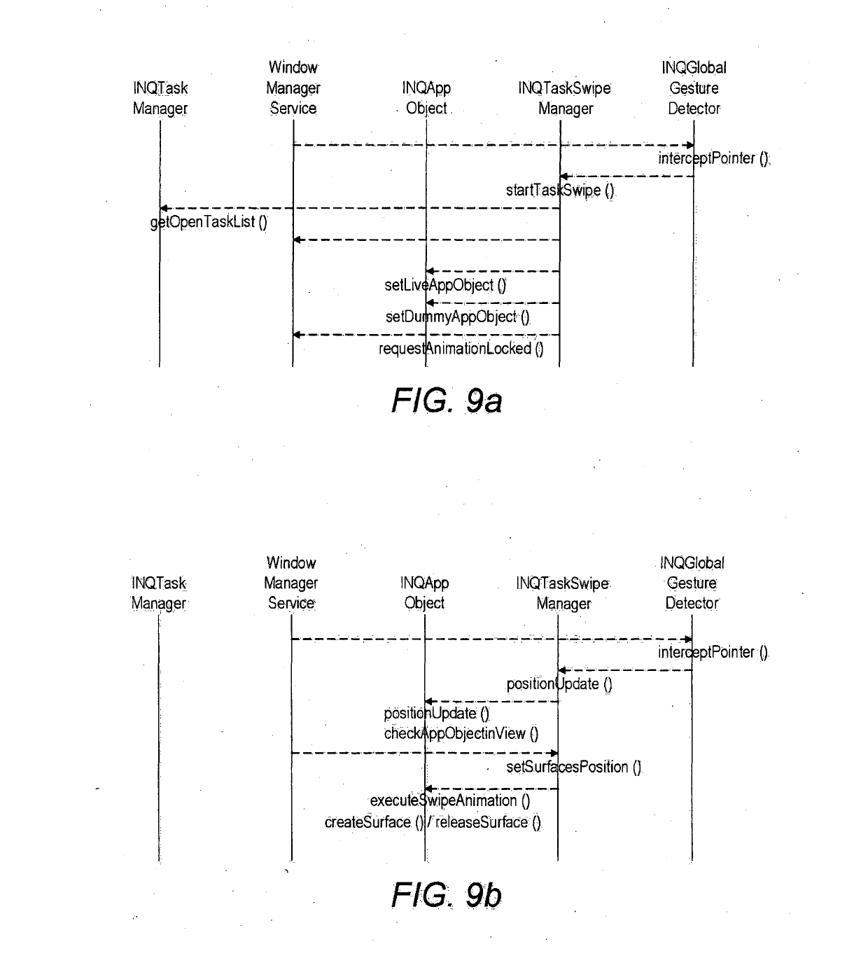

FIG. 8 is a simplified view of the front surface of the electronic device of FIG. 4 and the various surfaces that may be displayable on the screen of the device;

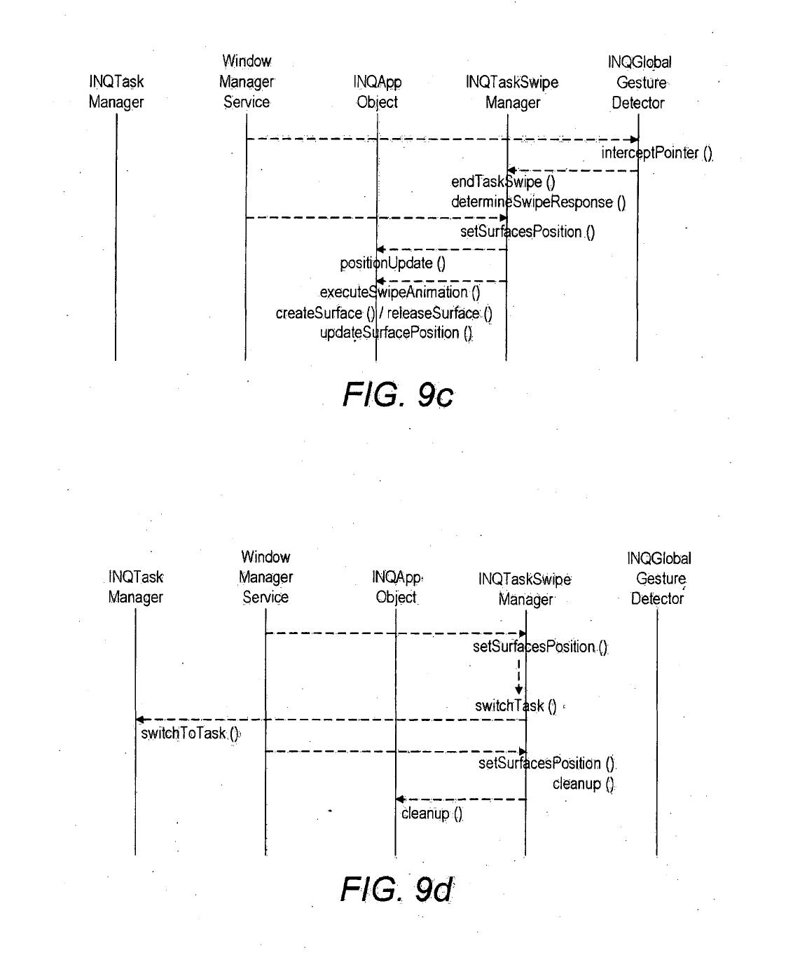

FIGS. 9a to 9d show sequence diagrams for four use cases relating to the swiping and switching that is carried out by the device of FIG. 4;

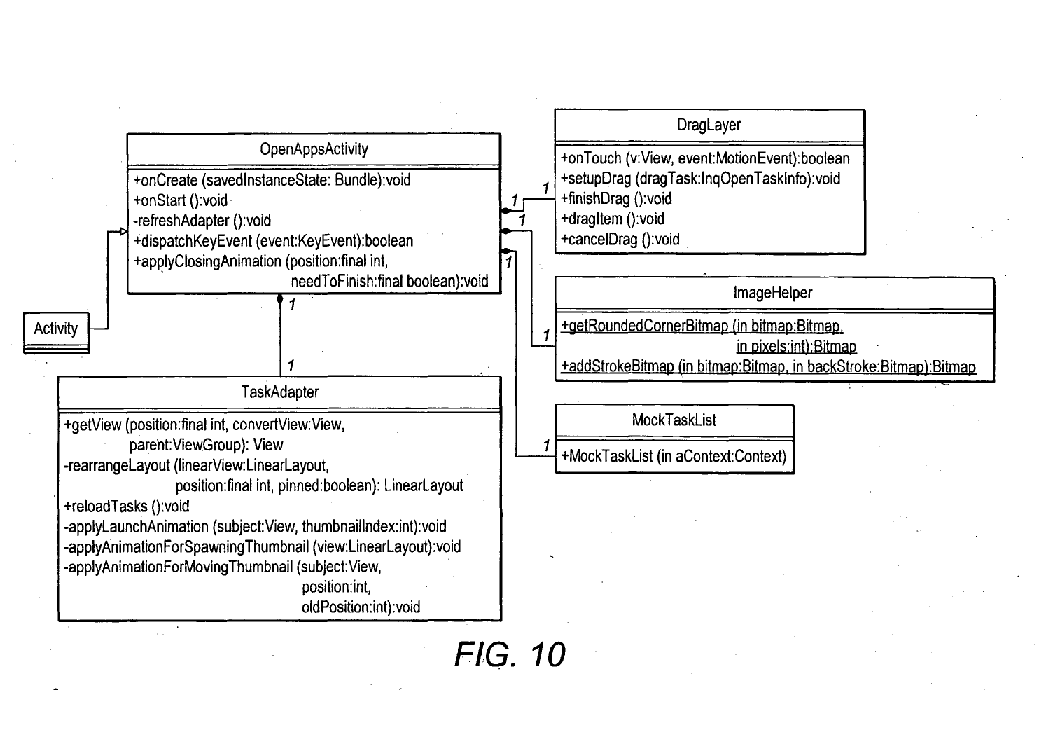

FIG. 10 shows a class diagram outlining the changes made to various aspects of the Android operating system of FIG. 2; and

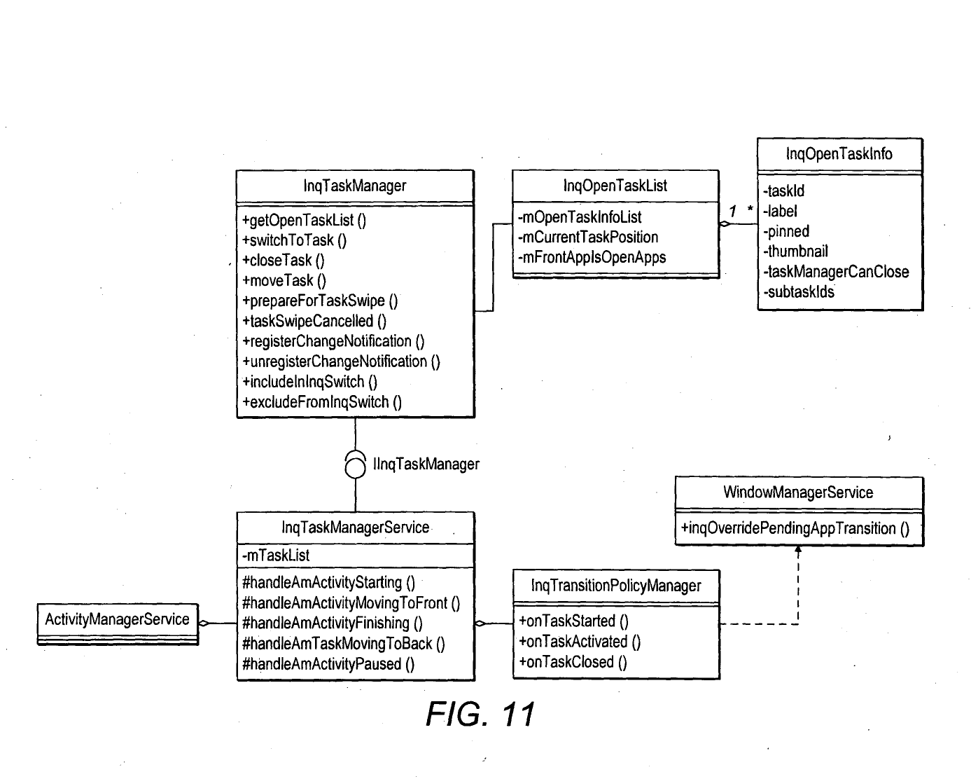

FIG. 11 shows a class diagram of an overview of the task manager component that is used in a mobile electronic device such as that in FIG. 4.

The mobile telephone has evolved significantly over recent years to include more advanced computing ability and additional functionality to the standard telephony functionality and such phones are known as “smartphones”. In particular, many phones are used for text messaging, Internet browsing and/or email as well as gaming. Touchscreen technology is useful in phones since screen size is limited and touch screen input provides direct manipulation of the items on the display screen such that the area normally required by separate keyboards or numerical keypads is saved and taken up by the touch screen instead. Although the embodiments of the invention will now be described in relation to handheld smartphones, some aspects of the invention could be adapted for use in other touch input controlled electronic devices such as handheld computers without telephony processors, e-reader devices, tablet PCs and PDAs.

FIG. 1 shows an exemplary mobile telephone handset, comprising a wireless communication unit having an antenna 101, a radio signal transceiver 102 for two-way communications, such as for GSM and UMTS telephony, and a wireless module 103 for other wireless communication protocols such as Wi-Fi. An input unit includes a microphone 104 and a touchscreen 105 provides an input mechanism. An output unit includes a speaker 106 and a display 107 for presenting iconic or textual representations of the phone's functions. Electronic control circuitry includes amplifiers 108 and a number of dedicated chips providing ADC/DAC signal conversion 109, compression/decompression 110, encoding and modulation functions 111, and circuitry providing connections between these various components, and a microprocessor 112 for handling command and control signalling. Associated with the specific processors is memory generally shown as memory unit 113. Random access memory (in some cases SDRAM) is provided for storing data to be processed, and ROM and Flash memory for storing the phone's operating system and other instructions to be executed by each processor. A power supply 114 in the form of a rechargeable battery provides power to the phone's functions. The touchscreen 105 is coupled to the microprocessor 112 such that input on the touchscreen can be interpreted by the processor. These features are well known in the art and will not be described in more detail herein.

In addition to integral RAM and ROM, a small amount of storage capacity is provided by the telephone handset's Subscriber Identity Module (SIM card) 115, which stores the user's service-subscriber key (IMSI) that is needed by GSM telephony service providers and handling authentication. The SIM card typically stores the user's phone contacts and can store additional data specified by the user, as well as an identification of the user's permitted services and network information.

As with most other electronic devices, the functions of a mobile telephone are implemented using a combination of hardware and software. In many cases, the decision on whether to implement a particular functionality using electronic hardware or software is a commercial one relating to the ease with which new product versions can be made commercially available and updates can be provided (e.g. via software downloads) balanced against the speed and reliability of execution (which can be faster using dedicated hardware), rather than because of a fundamental technical distinction. The term ‘logic’ is used herein to refer to hardware and/or software implementing functions of an electronic device. Where either software or hardware is referred to explicitly in the context of a particular embodiment of the invention, the reader will recognize that alternative software and hardware implementations are also possible to achieve the desired technical effects, and this specification should be interpreted accordingly.

A smartphone typically runs an operating system and a large number of applications can run on top of the operating system. As shown in FIG. 2, the software architecture on a smartphone using Android operating system (owned by Google Inc.), for example, comprises object oriented (Java and some C and C++) applications 200 running on a Java-based application framework 210 and supported by a set of libraries 220 (including Java core libraries 230) and the register-based Dalvik virtual machine 240. The Dalvik Virtual Machine is optimized for resource-constrained devices—i.e. battery powered devices with limited memory and processor speed. Java class files are converted into the compact Dalvik Executable (.dex) format before execution by an 10 instance of the virtual machine. The Dalvik VM relies on the Linux operating system kernel for underlying functionality, such as threading and low level memory management. The Android operating system provides support for various hardware such as that described in relation to FIG. 1. The same reference numerals for the same hardware appearing in FIGS. 1 and 2 is used. Support can be provided for touchscreens 105, GPS navigation, cameras (still and video) and other hardware, as well as including an integral Web browser and graphics support and support for media playback in various formats. Android supports various connectivity technologies (CDMA, WiFi, UMTS, Bluetooth, WiMax, etc) and SMS text messaging and MMS messaging, as well as the Android Cloud to Device Messaging (C2DM) framework. Support for media streaming is provided by various plug-ins, and a lightweight relational database (SQLite) provides structured storage management. With a software development kit including various development tools, many new applications are being developed for the Android OS. Currently available Android phones include a wide variety of screen sizes, processor types and memory provision, from a large number of manufacturers. Which features of the operating system are exploited depends on the particular mobile device hardware.

Activities in the Android Operating System (OS) are managed as an activity stack. An activity is considered as an application that a user can interact with. When a new activity is started, it is placed on the top of the activity stack and becomes the running activity. The previous activity remains below it in the stack, and will not come to the foreground again until the new task exits. A task is a sequence of activities which can originate from a single or different applications. In Android, it is possible to go back through the stack.

The inventors have realised a new framework to enable navigating through (back or forward) applications in mobile electronic devices using the Android OS and the capability of maintaining an ordered list of applications in the system. Screenshots of non-active applications are used and held such that navigating between screenshots relating to each application is possible. The applications are considered user tasks which are different to system tasks which may occur in the background without associated graphical user interfaces.

Referring to FIG. 3, various user interfaces of a mobile electronic device of one embodiment of the invention are shown. A main menu screen is shown which includes a number of applications which can be opened/activated through a user carrying out a particular interaction with graphical user interface objects representing the applications. In Android, the main menu screen is one of a number of Home screens. Each Home screen can include application icons, widgets, or other information that the user may wish to view. In this case, the user has selected “Messaging” application from the main menu Home screen by tapping on the associated object. This opens the Messaging application. The user then presses the “Home” key (not shown) on the mobile electronic device to take the user back to the main menu or Home screen for selection of another application to open. This can be carried out a number of times and in this case three applications are opened. Only one of the applications is fully visible at any one time when the user is not interacting with the applications. The order of the applications is shown in the figure with the Home screen being shown first and the remaining applications ordered chronologically (most recently shown first). The applications spawn to the right of the Home screen.

FIGS. 4a to 4d show a mobile electronic device 10 that may be used in FIG. 3. The mobile electronic device 10 has a gesture control area 11 which can be considered an extended part of a touch screen on the front of the device 10. A display area 12 is also provided which has a graphical user interface. In this particular example, the user has accessed a particular type of Home screen which is a Facebook social networking widget 13 by swiping across the display area 12 until the required Home screen is shown. The user has then selected the Chat icon 14. FIG. 4a to FIG. 4d shows the transition of the display screen when a user swipes (indicated by “F1”) from left to right across the gesture control area 11 after the Chat icon 14 has been selected and the Chat task 15 has been activated. In swiping the gesture control area 11 from the left side towards the right side, the entire Chat full screen moves to the right. A swipe is an example of a type of gesture that is a direct manipulation of the screen which can cause a change to the item(s) shown on the screen.

As shown in FIG. 4b, directly adjacent (connected) to the left edge of the Chat screen is the Facebook widget screen 13 from which the Chat task 15 was originally activated. Moving further along the gesture control area 11 leads to more of the Facebook widget screen 13 being shown (and less of the Chat screen 15) as shown in FIG. 4c. Once the swipe is near or at the right end of the gesture control area 11, only the Facebook widget screen 13 is viewable on the screen. It will be appreciated that this example only shows two screens (Facebook widget screen and Chat screen) but a number of applications may be in the stack in which case the user can swipe between all of them by swiping forward or backward in the gesture control area in the particular order that they are maintained in the device. For example, if a link is provided in the Chat screen, selecting the link will open the link in a screen adjacent to the Chat screen. The screen (not shown) relating to a link which may be a webpage for example, would open the browser application and bring it to the foreground. A user can then swipe backwards across the gesture control area once in the browser application and this can take the user back to the Facebook widget screen 13.

Task swiping involves animating a live surface and a screenshot simultaneously, then replacing the screenshot with a second live surface. The live surface will be the application which is currently on the screen and in focus (for example, the Chat screen 15 shown in FIG. 4a) and a screenshot of another application (eg. Facebook widget screen 13) is animated at the same time as shown in FIGS. 4b and 4c. Replacing the screenshot with a live surface is when the application is changed after the task swiping animation such as that shown in FIGS. 4b and 4c. Conventionally, a transition animation is performed when the application is changed. In this embodiment, conventional application transitions are suppressed when task swiping.

Another aspect will now be described which relates to how to re-order tasks or close tasks referring to FIGS. 5a and 5b. FIG. 5a shows a screen that is generated in an embodiment when a user long presses (as indicated by F2) a “Home” button on gesture control area. Other methods of activating the screen may be provided. Pressing the button, brings up an open applications screen 16 which shows a visual representation of every application that is open and you can switch to. In this screen, it is possible to move any application in the stack by dragging and dropping the indication of the application into another position in the stack. In this case, as shown in FIG. 5b, the user has selected the “Contacts” application (as shown by F3) and this can be moved anywhere in the stack. This allows the swipe order to be changed by the user.

This can be useful where the user may not wish to have to swipe between multiple applications but have tasks in the form of screenshots of each open application adjacent each other. For example, if a number of links are to be copied from one application to another and this can not be copied in a single action, the user may need to swipe across multiple screens if the screen to which the links are to be copied are further down the stack to the application from which the links originated. The capability of re-ordering the applications overcomes this and provides the user more control since a slower, more controlled swipe can be performed between adjacent application screens rather than a more uncontrollable swipe between distant applications in the stack.

If some of these applications are no longer needed, they can be individually closed from the open applications screen 16 by tapping on a close button (shown as a cross in the corner in FIGS. 5a and 5b) of the visual representation of the application.

Other types of gesture may be recognised on this screen 16 to cause the behaviour of the applications to change. For example, a user may long press and swipe a thumbnail of a particular application on the open applications screen towards the edge of the display area 12. If another portable electronic device is located adjacent to the portable electronic device 10 and Near Field Communication (NFC) is enabled on both devices, this could be a method of sharing data relating to the particular application between multiple portable electronic devices.

With this multi-tasking solution, it is also possible to handle background processes for applications such as Spotify. A Spotify application may be activated and a song may be selected to play. If the application is exited, Spotify will continue to run in the background but will not be open to allow switching between it and other applications that are open. Long pressing on the gesture control area can be carried out to bring up the open applications view. The Spotify application will not be in the list since it is running in the background. If the Spotify application was opened again, and whilst in the application, the open applications view is activated, Spotify will be represented like all of the other apps in the stack and the application can be rearranged if desired.

FIG. 6 is an architecture showing a list of classes and their interactions to provide task swiping in a mobile electronic device such as that in FIG. 4. It will be appreciated that other types of mobile electronic device could be used.

WindowManagerService is a standard Android service that controls all window drawings and animations in the system. INQGestureDetector is a specific class, singleton, created at boot time. Its purpose is to intercept pointer events in the gesture control area and process the events to determine the type of event such as if the event is a task swipe or a vertical gesture. INQTaskSwipeManager is a specific class, singleton, created at boot time and its purpose is to control switching between tasks. INQTaskManager provides an interface to INQTaskManagerService and maintains a tasklist and allows for tasks to be launched and/or closed. INQSurfacePool is a specific class, singleton, created at boot time. Its purpose is to handle creation, deletion and resiting of surfaces used in task swiping. INQAppOblect is a specific class which represents an open task in the task list. An array of INQAppObjects is created per task swipe.

Further details of the interaction between the different classes are provided below.
1) WindowManagerService creates INQTaskSwipeManager at boot time initialising it with the dimensions of the device. Then during an animation loop setSurfacesPosition( ) is called to move surfaces which are involved in task swipe.
2) INQGestureDetector is created at boot time. Then every touch event in the system is routed via interceptPointer( ) method. All touch events which are deemed to be part of a gesture are consumed (i.e. don't pass up the stack).
3) INQGestureDectector determines when swipe start/end and calls StartTaskSwipe( ) EndTaskSwipe( ) and PositionUpdate( ) on INQTaskSwipeManager. This passes both the position swiped and current rotation, these parameters control swiping.
4) When informed a swipe is started the current INQOpenTaskList is queried from the INQTaskManager, this list and tasks in it are used to initialise swiping. When a swipe is complete if it is required to switch tasks the INQTaskManager is informed which task to switch to.
5) INQSurfacePool maintains a pool of Surface objects, these objects are used to render task swipe bitmaps too.
6) An array of INQAppObjects is created for each task swipe, these objects calculate, control and issue position commands to move surfaces to create task swipe.

INQTaskManager is tightly integrated into the conventional Android ActivityManagerService. It augments the Activity stack of Android. The task list always has a Home screen at position 0 and contains all the tasks in the system in the correct order. New tasks are added when launched, the most recently launched task is positioned to the right of the Home screen. Tasks remain in the task list until they are closed. The INQTaskManager also maintains a record of the current task (i.e. that which is currently on the screen) and screenshots (eg. captured as bitmaps) for each task. It provides a list of visible tasks (some are hidden) which are used in task swiping and using the functionality of the open applications screen.

Before task swiping is initiated, the application currently on the screen is the top most activity in the activity stack. It is the window currently visible and it has a live surface which has been allocated by the system. The surface contains a user interface drawn by the application.

The task swiping is used to navigate through open tasks or applications in the system. During task swiping, a screenshot of the next task is drawn into a dummy surface. The position of this dummy surface is altered on the screen. The position of the live surface is altered to move in conjunction with the dummy surface.

Moving an input such as a user's finger to the left of the current live surface screen will cause the system to display the live surface of the current task and a screenshot dummy surface of the task to the right of the current task in the task list. While the user has their finger on a predetermined area of the screen such as the gesture control area, the surfaces will move in response to finger movements. When a user removes their finger, the live surface either slides back or transitions to the screenshot dummy surface. If the latter, the task is switched and the screenshot is replaced with a live task. INQTaskSwipeManager will transition to the screenshot of the dummy surface and call INQTaskManager to switch the task to the new task.

FIG. 7 shows the different components that are integrated into the operating system framework (in this case Android) to provide for gesture detection and task swiping. In the conventional Android framework, an input device reader component 20 is provided which has a KeyInputQueue function 21. KeyInputQueue function deals with translating raw input events into the correct type. Motion events in the gesture control area 11 are allowed up the stack. KeyInputQueue also controls virtual keys. An input event dispatcher component 22 includes a WindowManagerService function which creates a thread to read an input event from the KeyInputQueue function and dispatches events through the system to the correct window (i.e. the window that has focus and for which the input applies).

The input event types can include key inputs and pointer inputs and in the present embodiment, INQGlobalGestureDetector function intercepts all pointer events. If the event is in the gesture control area 11, these events are consumed by INQGestureDectector and the events are used to control task swiping. INQGlobalGestureDetector calls StartTaskSwipe( ) positionUpdate( ) and EndTaskSwipe( ) in INQTaskSwipeManager function to control task swiping.

As mentioned with respect to FIG. 6, StartTaskSwipe( ) is called when finger tracking mode is entered and the positionUpdate( ) is called every time a move event is received by INQGestureDetector while in finger tracking mode. The endTaskSwipe( ) is called when finger tracking mode is exited.

FIG. 8 shows a simplified view of the display screen 12 and gesture control area 11 of FIGS. 4A to 4D and the transition that is displayed in terms of the hereinbefore described live surface 12A and dummy surface 12B when a user carries out a swipe gesture which is preferably in the gesture control area 11. In this example, the live surface 12A is displayed on the display screen 12. A user's finger is moved from location X to the left of the gesture control area 11 towards location Y. The live surface moves to the left and the dummy surface 12A is displayed to the right of the live surface. In terms of position change:

X=Initial Position=204

Y=Current Position=39

DeltaPosition=(Y−X)/DisplayWidth

DeltaPosition=(39−204)/320=−0.516

The negative delta position is passed to INQTaskSwipeManager. On the other hand (not shown in the figure), if the finger is moved to the right of the gesture control area 11, the live surface moves to the right and the dummy surface to the left of the current surface is displayed. This creates a positive delta position and this is passed to INQTaskSwipeManager.

Task Swiping works in portrait mode and both landscape modes (90 degrees and 270 degrees). Changing the screen orientation, changes the display coordinates since the 0, 0 point is changed.

The task switching will be described in further detail with reference to FIGS. 9a to 9d which show sequence diagrams for four use cases relating to the swiping and switching that is carried out in embodiments of the invention.

There are four stages to task swiping (1) starting task swipe—FIG. 9a (2) executing task swipe—FIG. 9b (3) execute swipe response—FIG. 9c (4) switch task—FIG. 9d

(1) Starting Task Swipe—See FIG. 9a
Every Motion event is passed to INQGlobalGestureDetector interceptPointer( ) method. If the gesture state is idle and a Motion Down event is received in the touch strip area then startTaskSwipe( ) is called on INQTaskSwipeManager
StartTaskSwipe( ) gets the current INQTaskList from INQTaskManager by calling getOpenTaskList( ). This returns information on each task in the system and which is the current task.
INQAnimateLiveWindows( ) is called to set animation objects on AppWindowTokens and WindowState objects which are required to be moved as part of the task swipe.
If the corresponding live windows are found an INQAppObject is created to represent the current task, an array of INQAppObjects is created one for each task in the INQTaskList. setLiveAppObject( ) sets the live surface, setDummyAppObject( ) sets up dummy surfaces with screenshots.
If AppObjects are created successfully requestAnimationLocked( ) is called to request WindowManagerService starts animating.

(2) Executing Task Swipe—See FIG. 9b
When in a task swiping state motion movements events are intercepted and consumed by INQGlobalGestureDetector. Delta position information is passed to INQTaskSwipeManager position Update( )
The updated position is passed to each INQAppObject object, each object checks whether it is currently in the view based on the delta position and its position in the task list. These methods run in the context of the input dispatcher thread of WindowManagerService.
Then separately setSurfacesPosition( ) is called on INQTaskSwipeManager, this is called as part of the WindowMangerService animation loop (called from PerformLayoutAnd PlaceSurfacesLocked Inner( )). This calls executeSwipeAnimation( ) on each object.
If the objects are not currently in view then immediately returns, otherwise Surfaces are created and released as required (this can be done as we are in the context of Surface global transaction). Surfaces are moved to correct positions.
The overall result is that the current task moves left/right with the user's finger and a screenshot of the dummy surface to the left/right is shown as appropriate.

(3) Execute Swipe Response—See FIG. 9c
INQTaskSwipeManager is called to reflect this determineSwipeResponse( ) determines what should happen when the user takes their finger off the touch strip, the decision to transition back to original screen or to change to a specific screen is based on the distance moved and the velocity of movement.
At this point the swipe has ended, therefore no new position updates are given from INQGestureDetector, however determineSwipeResponse( ) calculates how long the response movement should be.
Then on subsequent calls of setSurfacesPosition by WindowManagerService the correct position of the “phantom finger) is calculated and positionUpdate( ) is called on each INQAppObject to move the surfaces accordingly.
After positionUpdate( ) has been called the same sequence of calls as in task swipe state is made to create/remove/move surfaces as required. The net result is therefore that surfaces move to their desired destination position.

(4) Switch Task—See FIG. 9d
When the duration for the swipe response has completed (i.e. surfaces have moved to their final place) a delayedMessageHandler is called which calls switchTask( ) 300 ms later. This time delay is one of many features to allow for multiple swiping. switchTask( ) looks up the taskID of the task which it is desired to switch to and passes this to INQTaskManger.
switchToTask( ) this component issues commands on ActivityManagerService to switch Android to new task.
When the task switch has been completed WindowManagerService calls setSurfacesPosition( ) and this causes both INQTaskSwipeManager and array of INQAppObjects to call cleanup( ) which removes all screenshot surfaces and returns state to idle ready for next swipe.

FIG. 10 shows a class diagram outlining the changes made to the Android system in order to enable use with the embodiments of the invention and particularly the aspect of re-ordering of tasks. A number of modules as shown in FIG. 10 provide the functionality of the open applications screen 16 of FIGS. 5a and 5b.

Referring to FIG. 10, the OpenAppsActivity deals with creating and closing the open applications screen and implements the layout and animations of the open applications screen. DragLayer deals with all of dragging and dropping actions which are used to move the visual representation (i.e. miniature screenshots or thumbnails) of every application that is open in open applications screen 16. ImageHelper provides the functionality of re-creating bitmaps with round corners and adding stroke (i.e. applying rounded corners to images such as fonts to attempt to make them more like natural flowing handwriting) on Bitmaps. MockTaskList enable creation of a dummy task list for debugging purposes.

In use, task list information is accessed by calling TaskManagerService only at the beginning stage of creating the open applications screen 16 rather than each time when the open applications screen needs to load the task list information. This means, values can be remembered for reuse rather than calling functions each time to have the data calculated thereby saving time and processing effort.

FIG. 11 shows a class diagram of an overview of the task manager component that is used in embodiments of the invention. The INQTaskManagerService is registered as a new service with the service manager. This is within the context of ActivityManagerService. Relevant Activity state changes are passed from ActivityManagerService to INQTaskManagerService such as ActivityStart, ActitivityMoveToFront, ActivityPause etc. INQTaskManagerService is responsible for the following:
Handling Activity state changes received from ActivityManagerService and updating its own INQOpenTaskList composed of INQOpenTasklnfo objects;
Uses INQTransitionPolicyManager to load appropriate transitions for activity state changes that require them i.e. switching from current app to OpenApps (swiping between apps is handled elsewhere).

INQOpenTaskList is the representation of all running tasks/apps meant to be visible in INQSwitch (excludes apps such as phone app). Each open application is represented by an INQOpenTaskInfo object which maps to an Android HistoryRecord and holds a Screenshot and Thumbnail for that app. In addition to this, INQOpenTaskInfo has a flag to indicate whether or not the open applications screen 16 is visible in which case swiping between open applications is disabled.

When an activity is started, if the activity is part of new task, a new task record is created and added to the task list. If the activity is part of an existing task, the task record is updated. When an activity is moved to the front of the activity stack, the task record is updated. When an activity is terminated or when an application crashes, the task is removed from the task list. If it was the current task, the top activity of the previous task in the list is activated. When a task is moved to the background, the top activity of the previous task in the list is activated. When an activity is paused, a screenshot is taken and captured if possible.

A Home activity that may relate to an activity when a user presses the Home button thereby bringing up the Home screen such as that in FIG. 4a, is always the first task in the application list maintained in the INQTaskList. A HistoryRecord has a special flag for the Home activity. When a new Home activity is started, it is inserted at the first position in the INQTaskList. Any previous Home activity is marked as hidden.

A task that only contains non fullscreen activities must not be shown as a separate task. When a new non fullscreen task is started, INQTaskManager stores the non fullscreen task as a sub-task of the current task. When a client on the mobile device activates a task that has a sub-task, the sub-task is activated. INQTaskSwipeManager receives a list of all task identifications that are part of a task.

Screenshots are taken whenever an application that has focus, i.e. is visible to the user, is transitioned away from either by swiping or by pressing a dedicated key on the phone, for example the Home button. A new screenshot is required every time an activity is paused. Screenshots are taken from the framebuffer A screenshot is captured preferably only if there is no system window visible on the top of the current task and is captured before starting the transition animation (i.e. before the screen such as that shown in FIG. 4c is displayed). During task swipe, the screenshoot is captured before starting the swipe, not when the activity is paused. Therefore an accurate visual representation of the current task in focus is taken. This could be taken when a swiping input is detected in the gesture control area but before the visual representation of the transition of the surfaces on the screen is generated and displayed. Every task has a flag to know if a new screenshot is needed or not. This can be set on the basis of a query having been carried out to determine if the window is top visible.

INQTaskManagerService handles the ActivityPaused state and taking a screenshot to store in the INQOpenTaskInfo for that application. It also handles the PrepareForTaskSwipe call from INQTaskManager to trigger taking a screenshot of the current app and updating INQOpenTaskInfo before swiping is commenced.

INQTaskManager forwards the call from INQGlobalGestureDetector and PrepareForTaskSwipe when a user touches the gesture control area 11 (see FIG. 4a) to INQTaskManagerService.

INQScreenshot is responsible for making a native call to grabscreenshot( ) which captures a bitmap from the framebuffer of the current visible screen. It handles cropping (removing the system status bar) and rotating the returned bitmap for use as screenshot in INQOpenTaskInfo.

Certain applications may use GLSurfaceView or VideoView. There may be applications that override the default Android activity Activity.onCreateThumbnail. Any of these types of applications will cause a black screenshot or thumbnail to be captured if using the default ActivityOnPause screenshot and thumbnail capture approach. This is addressed by grabbing the raw data as composited in the framebuffer by the graphics hardware and creating a screenshot and thumbnail from the captured bitmap.

It will be appreciated that the invention is not limited for use with a particular type of mobile communication device. Although the Android operating system has been described, the invention could be used with other operating systems for which task switching is not possible using the concepts described herein.

In addition to the embodiments of the invention described in detail above, the skilled person will recognize that various features described herein can be modified and combined with additional features, and the resulting additional embodiments of the invention are also within the scope of the invention.

1. A portable electronic device comprising a display screen area for providing visual feedback and for receiving gestures inputs, and a switching controller to enable switching between multiple applications that have been executed on the device, the switching controller being adapted to interact with an operating system on the device and including a number of software components that interact with components that are native to an operating system on the device, and wherein the device further comprises a processor for invoking procedures relating to the particular components of the switching controller, wherein the switching controller comprises a task management component for maintaining an ordered list of tasks that are running on the device and allowing for task status to be changed.

2. The device of claim 1, wherein the task management component maintains a chronologically ordered list of tasks that are running on the device.

3. The device of claim 1, wherein the task management component is operable to capture a screenshot of a task that has focus on the display screen and is running on the device when the task is transitioned away from.

4. The device of claim 1, wherein the switching controller further comprises a swipe manager component capable of switching between tasks.

5. The device of claim 1, wherein the switching controller comprises a gesture detection component to identify a particular type of gesture on a predefined area of the electronic device.

6. The device of claim 5 wherein identification of a particular type of gesture causes a pre-captured screenshot of a task on the task list to be displayed on the display screen simultaneously with and adjacent to the screen representation of the current task.

7. The device of claim 5 wherein the gesture detection component is associated with a gesture control area that is separate from the display screen area and outside the display screen area.

8. The device of claim 7 wherein the gesture control area recognises predetermined types of gestures which provide different functionality to the device compared to if the same gesture was received in the display screen area.

9. The device of claim 7 wherein a swipe gesture in the gesture control area is 10 detected by the gesture detection component and causes navigation through screenshots of the multiple applications without an intermediary application being displayed on the display screen after detection of the swipe gesture.

10. The device of claim 1, wherein the task management component is 15 adapted to capture a miniature screenshot of each tasks running on the device and to change the state of the tasks via direct manipulation of the miniature screenshot.

11. The device of claim 10, wherein the order of the tasks in the list of tasks is changed through direct manipulation of one or more of the miniature screenshots.

12. A method for controlling switching between a plurality of applications in a portable electronic device comprising a display screen wherein the method includes generating an ordered list of the plurality of applications that are running on a device and controlling switching between the applications on the basis of the list.

13. The method of claim 12 further comprising capturing a screenshot of a task that has focus on the display screen and is running on the device when the task is transitioned away from.

14. The method of claim 12 further comprising identifying a particular type of gesture on a predefined area of the electronic device, wherein identification of a particular type of gesture causes a pre-captured screenshot of a task on the task list to be displayed on the display screen simultaneously with and adjacent to the screen representation of the current task.

15. The method of claim 12, further comprising changing the order of the list.

16. A computer readable medium comprising computer program code for causing a device to control switching between a plurality of applications in a portable electronic device comprising a display screen, where said control comprises generating an ordered list of the plurality of applications that are running on a device and controlling switching between the application on the basis of the list.
